(19) United States
(12) Patent Application Publication
(10) Pub. No.: US 2008/0034296 A1
(43) Pub. Date: Feb. 7, 2008

(54) INTERFACE FOR SUMMARIZING PARTICIPATION-BASED PROGRAMS AND A USER'S PARTICIPATION LEVEL

(76) Inventors: NATHAN CHRISTOPHER BYBEE, Austin, TX (US); THEODORE JACK LONDON SHRADER, Austin, TX (US); JACKIE COLE WHEELER, Raleigh, NC (US)

Correspondence Address: IBM CORPORATION (SS), C/O STREETS & STEELE, 13831 NORTHWEST FREEWAY, SUITE 355, HOUSTON, TX, 77040, US

(21) Appl. No.: 11/462,738

(22) Filed: Aug. 7, 2006

(51) Int. Cl. G06F 3/00

(52) U.S. Cl. 715/741; 715/743

(57) ABSTRACT

Method and computer program product for displaying user participation in a Web application. At least one predetermined rule is established for a plurality of user participation levels based upon an amount of at least one parameter of activity on a Web application server. An amount of the at least one parameter of activity that is attributable to a particular registered user is measured and the at least one predetermined rule is applied to the measured amount of the at least one parameter to determine a current participation level for the registered user. The registered user is then provided with a graphical user interface that displays the current participation level of the registered user in relation to the plurality of participation levels. Optionally, the user interface is persistent and provides the registered user with instructions on reaching the next participation level and information about benefits available at that level.

### BACKGROUND OF THE INVENTION

1. Field of the Invention

The invention relates generally to methods of managing user interaction with a Web site.

2. Description of the Related Art

Most frequently, regardless of their level of sophistication, Web sites simply present a collection or collections of stand-alone content. Content items across a site may be related topically, such as through a series of articles on a given subject or a selection of competing products in an online catalog; but each item stands alone in that the user isn't required to read each article just to access the latest one, nor would they be required to evaluate every product in a catalog just to select the one they wanted to purchase. Instead users focus on the specific content items in which they are most interested and then they move on. Many Web sites that require users to register and maintain a unique login id and password often utilize these registrations for their own tracking purposes or to enhance their user experience, but not necessarily as part of some larger, long-term programmatic relationship.

Rarely are there conditional dependencies that require Web content to be accessed or viewed in a prescribed sequence. However, a familiar example of this would be completing an online purchase. A catalog of products may be a collection of stand-alone items, but as soon as a user selects the product(s) they want to purchase, a series of actions is set in motion that must be controlled. Product selections must be collected in a “shopping cart” until the user is ready to buy, the user's geographic location must be determined before taxes and shipping charges can be assessed, all such charges must be totaled before payment can be requested, the user must provide credit card or other financial information before any billing can occur, and the storefront must verify the transaction is complete before shipping.

Another example where controlled access to Web content is necessary would be a membership-based online community where each user's experience is individually tailored based on their unique status within the community. In many such cases, these programs are tiered along a “do this/get this” model that offers users greater benefits or access as their level of participation in the program grows. Numerous architectures and interfaces have been developed to organize and control an online shopping experience where each purchase is its own independent transaction. But these existing methods are inadequate for managing a membership-based Web site where data must be collected and stored, and where access to Web content must be dynamically controlled over a long-term relationship.

### SUMMARY OF THE INVENTION

The present invention provides a method for displaying user participation in a Web application and a computer program product including instructions embodied on a computer readable medium for displaying user participation in a Web application in accordance with the method. The method comprises establishing at least one predetermined rule for a plurality of user participation levels based upon an amount of at least one parameter of activity on a Web application server, measuring an amount of the at least one parameter of activity that is attributable to a particular registered user, applying the at least one predetermined rule to the measured amount of the at least one parameter to determine a current participation level for the registered user, and providing the registered user with a graphical user interface that displays the current participation level of the registered user in relation to the plurality of participation levels.

The method may further comprise the step of continuing to measure the amount of the at least one parameter of activity that is attributable to the registered user over a plurality of user sessions with the Web application server. Preferably, the graphical user interface is persistent during each user session with the Web application server. Most preferably, the graphical user interface is used to provide the registered user with instructions on activity that will change the current participation level to the next higher level in the plurality of user participation levels, information about additional benefits available at the next participation level, or a combination thereof.

In one embodiment, the amount of the at least one parameter of activity attributable to the registered user is stored in memory of the Web application server in a database record associated with the registered user. In another embodiment, the method provides benefits to the registered user based on the current participation level of the registered user. In yet another embodiment, the method includes measuring the amount of the at least one parameter of activity attributable to the registered user during each user session, and storing the measured amount of the at least one parameter of activity and a user session time-stamp for each user session, wherein the predetermined rule for determining a current participation level considers only the amount of the at least one parameter of activity attributable to the registered user during user sessions occurring in a defined time period.

### BRIEF DESCRIPTION OF THE DRAWINGS

FIG. 1 is a schematic diagram of a Web application server in communication with a computer system through a network.

FIG. 2 is a computer system having various typical input and output devices.

FIG. 3 is a schematic diagram of a computer system having a browser and network access for interacting with the Web application server.

FIG. 4 is a flowchart illustrating a method for displaying user participation levels in a Web application.

FIG. 5 is a flowchart illustrating a somewhat more detailed method for displaying user participation levels in a Web application.

FIGS. 6A-F are displays of an exemplary thermometer-style graphic user interface showing the user's level of membership at any one time.

### DETAILED DESCRIPTION OF PREFERRED EMBODIMENTS

The present invention provides a method for displaying user participation in a Web application. At least one predetermined rule is established within the Web application that defines a plurality of user participation levels based upon an amount of at least one parameter of activity on a Web application server. The Web application then measures an amount of the at least one parameter of activity that is attributable to a particular registered user. By applying the at least one predetermined rule to the measured amount of the at least one parameter of activity, a current participation level for the registered user is determined. The registered user is then provided with a graphical user interface that displays the current participation level of the registered user in relation to the plurality of participation levels.

In a graphical user interface of the present invention, the users' current participation level in the overall process may be indicated in various manners. For example, the current level may be indicated by a different color, brightness, font, use of borders, arrows or other symbols or icons. Furthermore, the current level may receive different treatment than levels both before and after the current level (i.e., only the current level stands out), or the treatment may be applied to all the levels up through the current level (i.e., current and previous levels stand out). Still further, the current and/or previous levels may be faded or removed so that only the remaining levels stand out. In the context of the participation program, the Web operator may determine whether the interface should continue to recognize past levels or focus solely on encouraging additional participation.

The user interface is preferably designed to show a linear progression of levels in a participation program, instruct the user as to where they are along that progression and indicate what future steps may need to be taken. While the graphical representation can be customized, a suitable representation may include, without limitation, a vertical thermometer-style progression or a horizontal bar-style progression. However, a vertical progression is likely preferred from a usability perspective because it can generally portray larger amounts of information in more compact areas of the display screen. In a particular implementation of the invention it may be important to keep the display compact, since a persistent display will consume screen real estate that cannot then be used for other aspects of the Web application. The user interface preferably displays a condensed view of a structured relationship between participation levels and facilitates navigation to the most relevant aspects of the program based on each user's unique position within that relationship.

In one embodiment, the content of the user interface may include links to further information about the participation level, for example explaining how the user achieved the particular level and what benefits may be realized by having reached that level. Other links may inform the user how to advance to yet another participation level. Alternatively, the user interface may simply display the information. The types of benefits that may be enabled or made available to a user upon achieving a higher participation level may include, for example, discounts on purchases, special offers, access to more content/graphics/audio, unlocking game features, and wallpaper.

Furthermore, if the number of potential participation levels is more than can be conveniently displayed in a compact manner, it is possible for the user interface to display only a portion of the participation levels. Optionally, the interface may display a scrolling representation that shows only relevant portions of the participation levels in the progression. Potentially, the scrolling interface would include a scroll bar to allow the user to view all the participation levels, if desired. However, it is preferred that the interface display at least the previous level, current level and next level at any one time in order to show the user their current participation level in the context of other participation levels.

Preferably, the Web application will allow or require a user to register himself by submitting various user information, such as a username and password. Optionally, the application may gather and store additional information about the user. In this manner, the Web application can measure and monitor a user's participation over a period of user sessions.

In one embodiment, the user information is stored in a registered user database maintained on the Web application server or other memory device accessible to the server. Accordingly, the Web application server can identify a registered user at login, store and retrieve parameters related to user participation in association with the user ID, and provide the registered user with a user interface having a personalized graphic that shows their participation level. Alternatively, if the application does not require a high level of security, the user login and/or user participation amounts or levels may be kept on the user's computer in the form of a stored cookie, session identifier, or other means. A “stored cookie” is a message that is stored on a user's hard drive and sent back to a particular sever every time the browser accesses the Web page until it is deleted by the user. Whether the user information is stored on the server or the user's computer, the current amount of accumulated participation should be uploaded into the Web application to generate the user interface with the personalized graphic.

A participation level may be based on activity-to-date, or activity during a moving period, such as the previous three months. The exact time period, and other decisions related to the establishment of rules for determining a current membership level, is a programmatic decision independent of the user interface itself. Since the interface is designed to act dynamically based on a user's amount of participation, any particular activity parameter could be considered by developing the business rules for such scenarios. Depending upon the circumstances, the interface may be suitably tailored to reflect those scenarios.

While a Web site may appear as single website, the invention encompasses the operation of separate websites to handle different functions of an integrated Web experience. As long as user identities and business rules are common among the sites, the actual number of sites is not a limitation of the invention. The user interface is intended to function wherever it is programmatically relevant across the entire collection of sites within that common login system and Web experience.

A registered user's participation or activity on a single website, or group of closely affiliated websites, can be tracked as soon as the user logs-in or otherwise is identified to the Web application. The participation or activity can be based upon any one or more detectable interaction with the membership program. Examples of suitable activity could include, but are not limited to, purchases, number of pages viewed, amount of time spent, games played or game scores, and contributions to content. Any such HTTP-based Web transactions can be tracked according to business needs. The selection of activities or participation parameters to measure is purely a programmatic decision. The interface itself does not collect and manage data, it is simply designed to reflect states of membership and level of benefits access as defined by the program owners and established in a set of predetermined rules from time to time.

Furthermore, the participation could be based fully or partially upon activity that occurs outside the program, but is reported to the program. For example, the accounting group of an auto dealership may report a salesperson's monthly sales to the Web application so that when a salesperson logs in to the dealership website or manufacturer website they are shown a user interface that includes their sales level (their participation level) among other possible sales levels and may provide information on the incentive awards received (benefits) and how to reach the next level. It should be recognized that other aspects of the website content or organization of the content may also be personalized to the user.

The rules that are programmed and used to determine a participation level based on measured participation or activity may provide a progression that is more or less gradual, but preferably the progression occurs in some limited number of steps. An individual user's participation level and benefits access is preferably based on their own participation independent of whether or not there is a community of others or those others' activities. This participation may be determined solely by a single parameter or determined by a formula involving multiple parameters. However, it should be recognized that a website can host a plurality or community of users, each user at their own level of participation, and it would be possible to show one's participation level as a ranking among other users. The interface is preferably designed to dynamically display each user's personal participation level to that specific user. In an embodiment where the registered users are considered to be members of an organization, the participation level may be considered a membership level.

In one embodiment, the user interface is persistent across the relevant portions of the at least one Web site and would be updated dynamically over the course of multiple user sessions and/or whenever there is a change in the participation level or new information or instructions to the user about how to affect their participation level. This dynamic interface could encompass any number of programming languages or commands, such as Java, Java Servlets, Java Server Pages (JSPs), PHP, ActiveX, or other programmatic actions. However, while any given implementation of the interface may incorporate various transactional technologies or languages, the interface itself can then be positioned on a Web page using standard Web display coding such as HTML. The Web application program resides on a Web application server, or is accessible to the Web application server, and does not require the installation of special software program components on the user's computer.

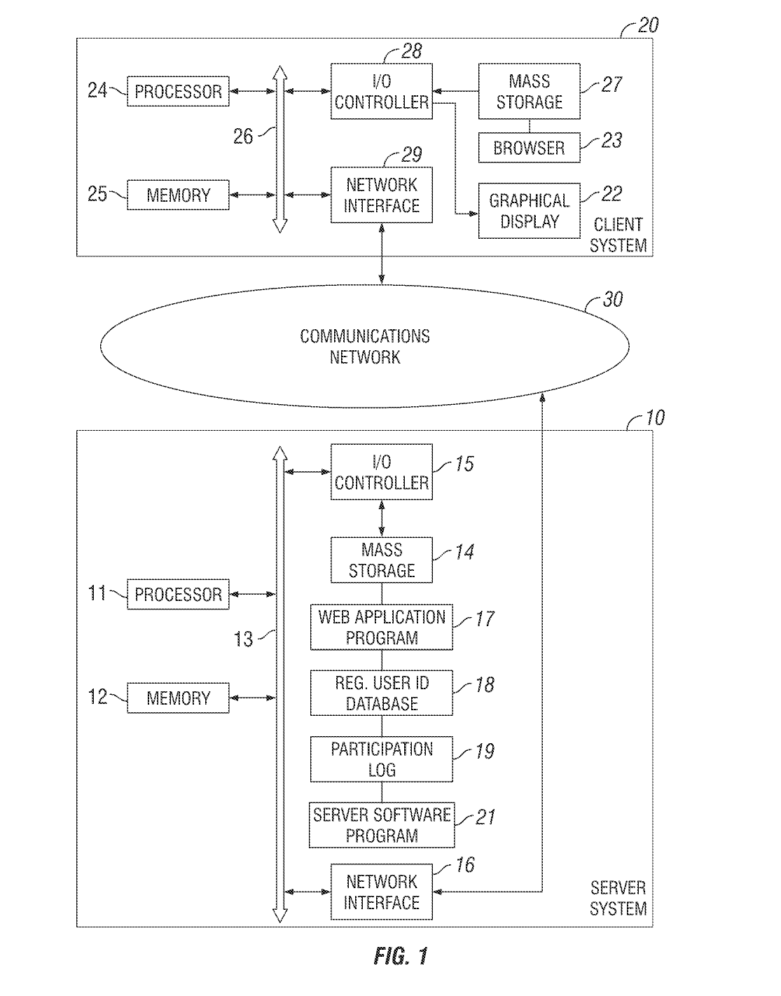

FIG. 1 is a schematic diagram of a Web application server system 10 in communication with an individual user's computer 20 through a network, such as the Internet 30. The user's computer 20 includes conventional components such as a processor 24, memory 25 (e.g. RAM), a bus 26 which couples the processor 24 and memory 25, a mass storage device 27 (e.g. a magnetic hard disk or an optical storage disk) coupled to the processor and memory through an I/O controller 28 and a network interface 29, such as a conventional modem. The Web application server system 10 also includes conventional components such as a processor 11, memory 12 (e.g. RAM), a bus 13 which couples the processor 11 and memory 12, a mass storage device 14 (e.g. a magnetic or optical disk) coupled to the processor 11 and memory 12 through an I/O controller 15 and a network interface 16, such as a conventional modem.

It should be appreciated that the present invention may be implemented in software that is stored as executable instructions on a computer readable medium on the Web application server 10, such as in mass storage device 14 or in memory 12. The Web application server system 10 is shown having a Web application program 17, a registered user identification database 18, and a participation database or log 19 stored in mass storage device 14. The Web application server 10 is thus suitable for processing: (1) user account registration, (2) user login and access to Web content, features and activities, (3) measuring user participation within the Web application, (4) determining participation levels, and (5) providing a personalized user interface showing the registered user's participation level among a plurality of possible participation levels.

The communications network 30 is the medium used to provide communications links between the Web application server 10 and any number of various devices and computers (individually represented as computer 20). The communications network 30 may include permanent connections, such as wire or fiber optic cables, or temporary connections made through telephone or wireless communications. A registered user's computer and the Web application server may be represented by a variety of types of computing devices, such as mainframes, personal computers, personal digital assistants (PDAs), smart phones, etc. The server system may include additional servers, clients, routers and other devices not shown. In the example of FIG. 1, the network system 30 may include the Internet (a worldwide collection of networks and gateways that use the TCP/IP suite of protocols to communicate with one another). Of course, the Web application server 10 may also communicate over a number of different types of networks, such as, for example, an intranet, a local area network (LAN), or a wide area network (WAN).

The present invention can be implemented on a variety of hardware platforms and can be implemented in a variety of software environments. A typical operating system may be used to control program execution within the data processing system. Furthermore, although the preferred embodiment described below includes a “browser” 23 at the registered user's computer as the agent that exchanges data in the security protocols with the Web application server, the agent at the registered user's computer does not have to be a conventional browser, such as Netscape Navigator® or Microsoft Internet Explorer®. In order to optionally secure the information transmitted to and from the server, the user's computer may be capable of Public Key Infrastructure (PKI) technology exchanged in a security protocol such as the Secure Sockets Layer (SSL) version 3.0 and above.

The Web application server 10 preferably operates a conventional server software program 21, such as International Business Machines' WebSphere®, for administering the participation-based Web application program. The server software includes application programs that enable the server 10 to manage user participation and apply predetermined rules or instructions to determine a participation level and provide corresponding benefits to a registered user.

The computer network 30 may be the Internet, an intranet, or other network. The server 10 may be a Web application server (WAS), a server application, a servlet process or the like. Optionally, the registered user's device 20 submits the required information to identify the registered user as being authorized to access the Web application. Registered user data may include a username and a password known by the Web application server 10. The application server 10 generates a graphical user interface that is displayed on a graphical display screen 22 by the browser 23 on the device 20. The Web application server 10 includes a user database 18 that contains records for each registered user that include the user identification, password used to access the Web application, and other user information. The participation data may be maintained in the same user database 18 or a separate participation database or log 19.

It should be recognized that the invention may take the form of an entirely hardware embodiment, an entirely software embodiment, or an embodiment containing both hardware and software elements. In particular embodiments, including those embodiments of methods, the invention may be implemented in software, which includes but is not limited to firmware, resident software and microcode.

Furthermore, the invention can take the form of a computer program product accessible from a computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD-read only memory (DVD-ROM), and DVD-read/write (DVD-R/W).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

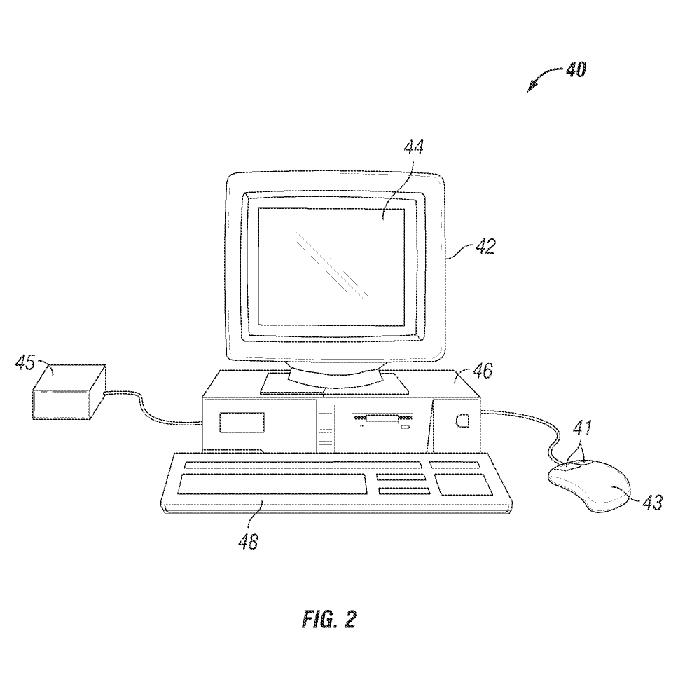

FIG. 2 is a computer system having various typical input and output devices. The computer system 40 is capable of running a browser. The computer system 40 includes a display device 42 (such as a monitor), a display screen 44, a cabinet 46 (which encloses components typically found in a computer, such as CPU, RAM, ROM, video card, hard drive, sound card, serial ports, etc.), a keyboard 48, a mouse 43 and a modem 45. The mouse 43 may have one or more buttons, such as buttons 41. The computer requires some type of communication device such as modem 45 that allows computer system 40 to be connected to the Internet. Other possible communication devices include Ethernet network cards.

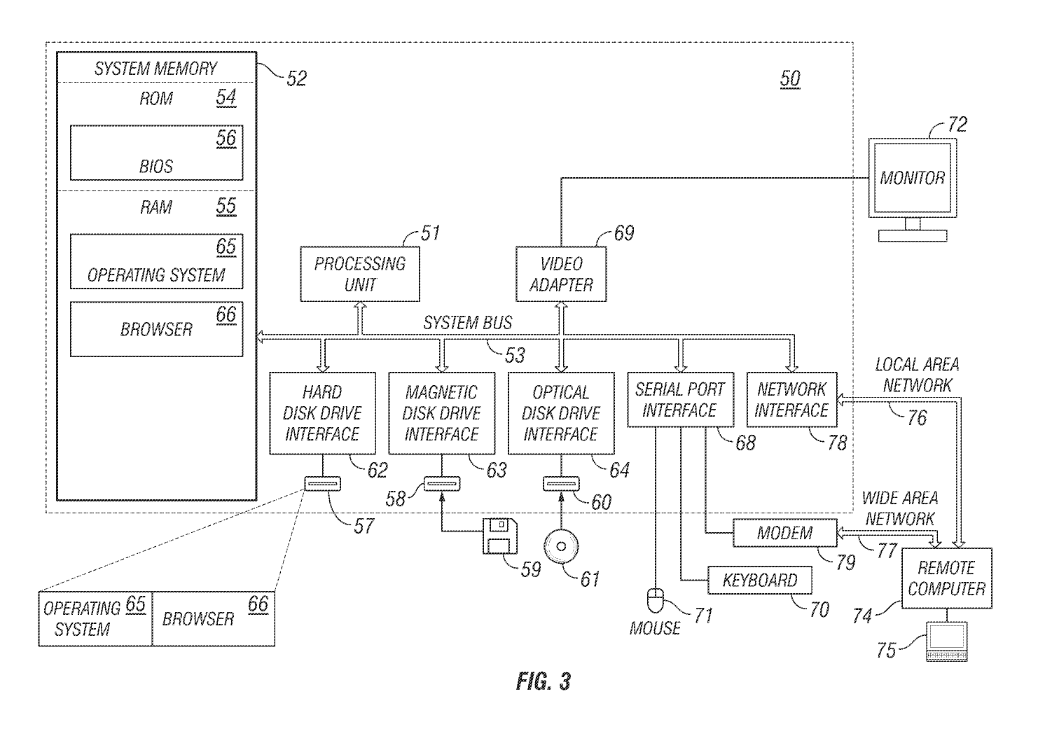

FIG. 3 is a schematic diagram of a computer system 50 that is capable of running a browser. The system 50 may be a general-purpose computing device in the form of a conventional personal computer 50. Generally, a personal computer 50 includes a processing unit 51, a system memory 52, and a system bus 53 that couples various system components including the system memory 52 to processing unit 51. System bus 53 may be any of several types of bus structures including a memory bus or memory controller, a peripheral bus, and a local bus using any of a variety of bus architectures. The system memory includes a read-only memory (ROM) 54 and random-access memory (RAM) 55. A basic input/output system (BIOS) 56, containing the basic routines that help to transfer information between elements within personal computer 50, such as during start-up, is stored in ROM 54.

Computer 50 further includes a hard disk drive 57 for reading from and writing to a hard disk 57, a magnetic disk drive 58 for reading from or writing to a removable magnetic disk 59, and an optical disk drive 60 for reading from or writing to a removable optical disk 61 such as a CD-ROM or other optical media. Hard disk drive 57, magnetic disk drive 58, and optical disk drive 60 are connected to system bus 53 by a hard disk drive interface 62, a magnetic disk drive interface 63, and an optical disk drive interface 64, respectively. Although the exemplary environment described herein employs hard disk 57, removable magnetic disk 59, and removable optical disk 61, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment. The drives and their associated computer readable media provide nonvolatile storage of computer-executable instructions, data structures, program modules, and other data for computer 50. For example, the operating system 65 and application programs, such as a Web browser 66, may be stored in the RAM 55 and/or hard disk 57 of the computer 50.

A user may enter commands and information into personal computer 50 through input devices, such as a keyboard 70 and a pointing device, such as a mouse 71. Other input devices (not shown) may include a microphone, joystick, game pad, satellite dish, scanner, or the like. These and other input devices are often connected to processing unit 51 through a serial port interface 68 that is coupled to the system bus 53, but input devices may be connected by other interfaces, such as a parallel port, game port, a universal serial bus (USB), or the like. A display device 72 may also be connected to system bus 53 via an interface, such as a video adapter 69. In addition to the monitor, personal computers typically include other peripheral output devices (not shown), such as speakers and printers.

The computer 50 may operate in a networked environment using logical connections to one or more remote computers 74. Remote computer 74 may be another personal computer, a server, a client, a router, a network PC, a peer device, a mainframe, a personal digital assistant, an Internet-connected mobile telephone or other common network node. While a remote computer 74 typically includes many or all of the elements described above relative to the computer 50, only a memory storage device 75 has been illustrated in the figure. The logical connections depicted in the figure include a local area network (LAN) 76 and a wide area network (WAN) 77. Such networking environments are commonplace in offices, enterprise-wide computer networks, intranets, and the Internet.

When used in a LAN networking environment, the computer 50 is often connected to the local area network 76 through a network interface or adapter 78. When used in a WAN networking environment, the computer 50 typically includes a modem 79 or other means for establishing high-speed communications over WAN 77, such as the Internet. A modem 79, which may be internal or external, is connected to system bus 53 via serial port interface 68. In a networked environment, program modules depicted relative to personal computer 50, or portions thereof, may be stored in the remote memory storage device 75. It will be appreciated that the network connections shown are exemplary and other means of establishing a communications link between the computers may be used. A number of program modules may be stored on hard disk 57, magnetic disk 59, optical disk 61, ROM 54, or RAM 55, including an operating system 65 and browser 66.

The described example shown in FIG. 2 does not imply architectural limitations. For example, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

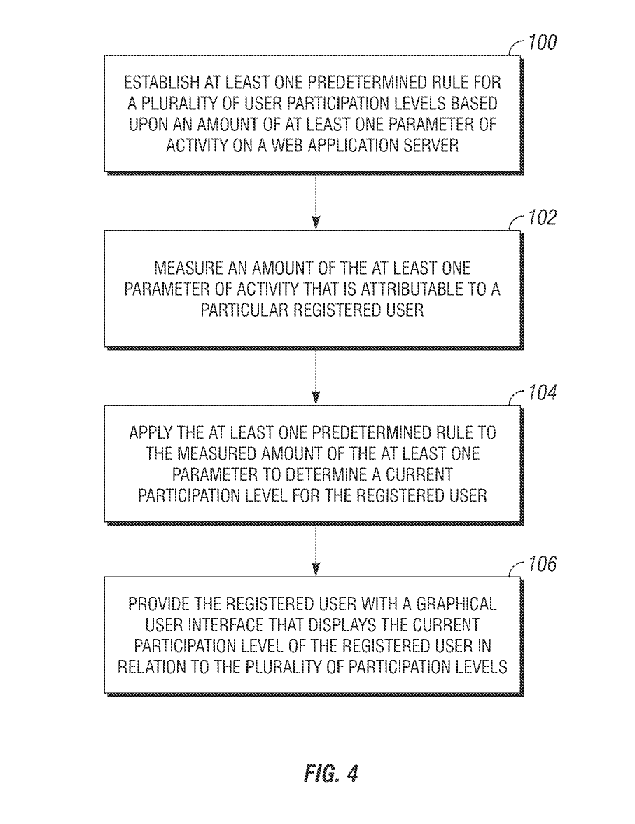

FIG. 4 is a flowchart illustrating a method for displaying user participation in a Web application. In step 100, the Web application program establishes at least one predetermined rule for a plurality of user participation levels based upon an amount of at least one parameter of activity on a Web application server. In step 102, the program measures an amount of the at least one parameter of activity that is attributable to a particular registered user. Next, in step 104, the at least one predetermined rule is applied to the measured amount of the at least one parameter to determine a current participation level for the registered user. The registered user is then provided with a graphical user interface in step 106, where the interface displays the current participation level of the registered user in relation to the plurality of participation levels. Typically, the steps of measuring activity (step 102), applying the rule(s) (step 104), and providing the interface (step 106) are repeated over time, either continuously, periodically, or upon the occurrence of some event such as a login beginning a new user session.

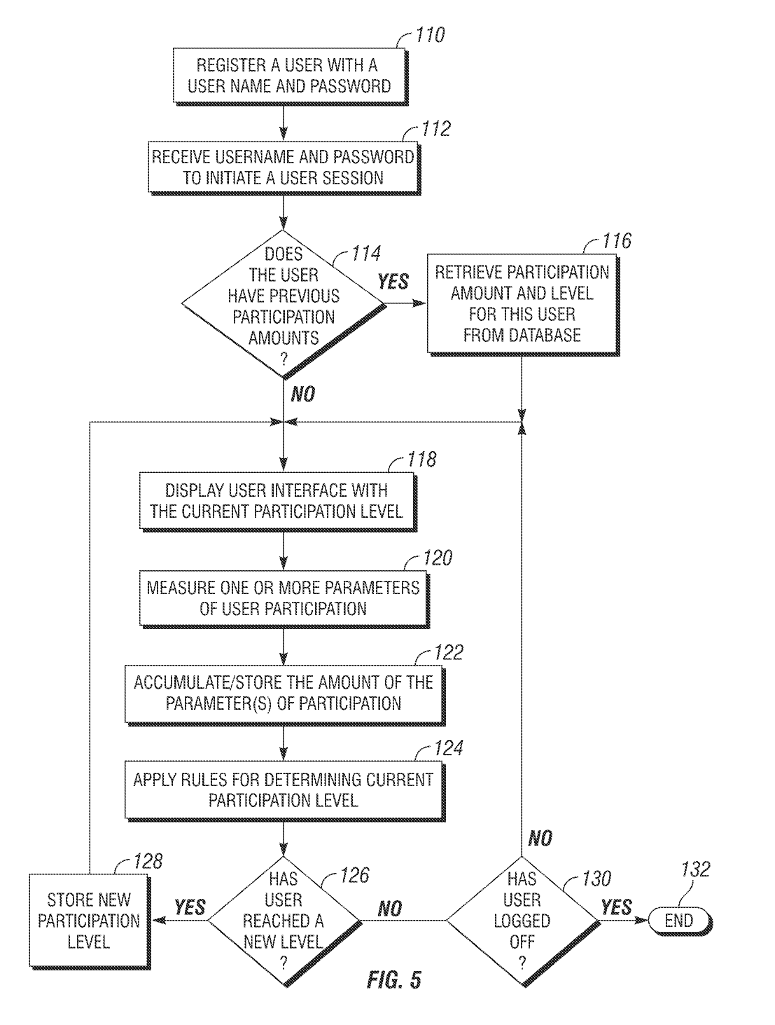

FIG. 5 is a flowchart illustrating a somewhat more detailed method for displaying user participation in a Web application. In a first step 110, a user is registered with the Web application and stores a username and password that will be used by the user to gain access to the application and to identify the registered user to the application. In the next step 112, the Web application receives the username and password from the user in order to initiate a new user session. The Web application then, in step 114, looks up the registered user, for example using the username and password, in its registered user database or participation database, to determine whether the user has any amount of participation that has been previously measured and stored. If an existing amount of participation or a participation level is found, then, in step 116, the Web application retrieves the participation amount or level from the database.

The method continues, at step 118, by displaying a personalized user interface with the current participation level to the registered user. The participation level is displayed in a format or graphic as previously described, such that the user's current participation level is shown and highlighted in some manner in relation to another participation level or levels in a progression. In step 120, the Web application measures one or more parameters of user participation with respect to the Web application. This measured amount of one or more participation parameter is then accumulated and stored, whether as a single participation record or log of individual participation records, in step 122. Then, in step 124, rules for determining the user's current participation level are applied to the amount of relevant participation.

Having identified the user's current participation level in step 124, step 126 determines whether the user has reached a new participation level. If the participation level is new, the new participation is stored in step 128 and the method returns back to step 118 in order to update the user interface, which is preferable persistently displayed during each user session.

However, if the user's current participation level has not changed, as determined in step 126, then step 130 determines whether the user has logged off. If the user has not logged off, then the method returns to step 118. If the user has logged off, thereby ending the user session, then the method ends in step 132.

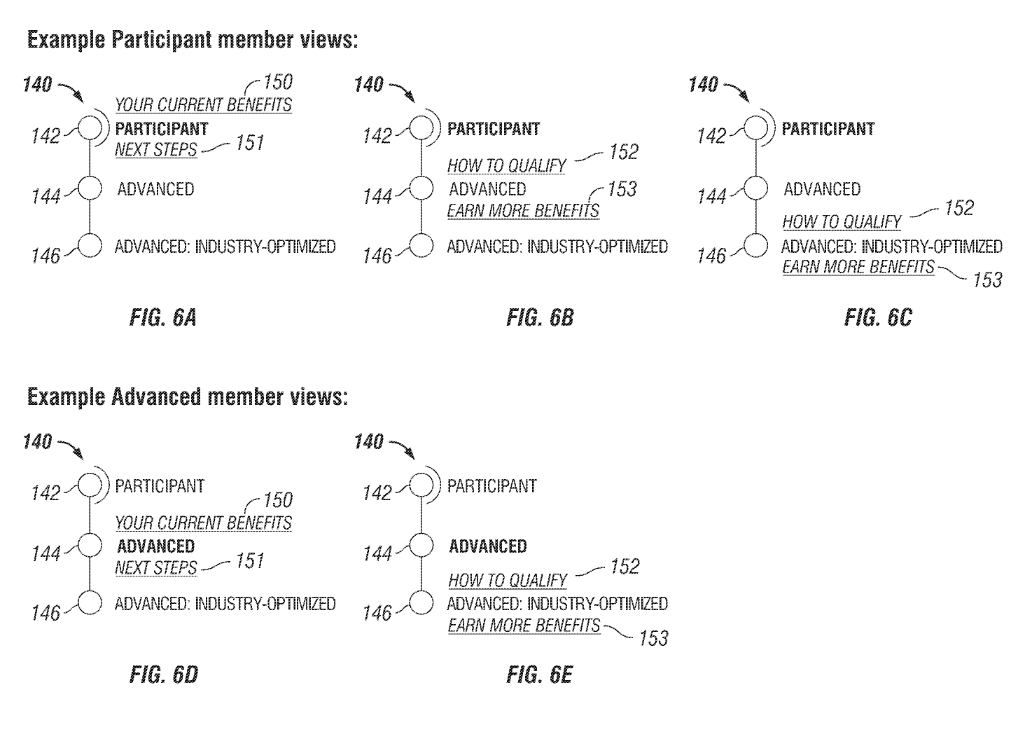

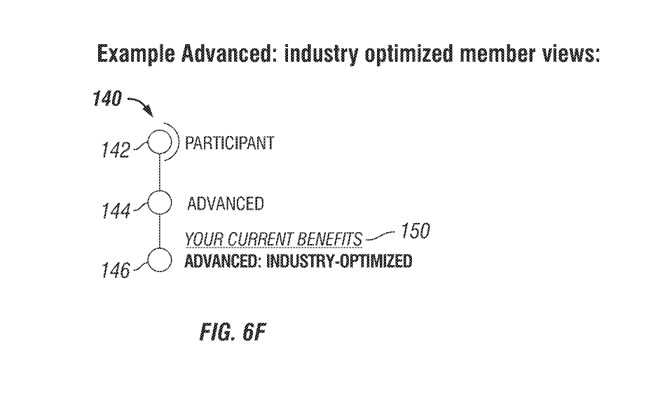

FIGS. 6A-F are designs of an exemplary thermometer-style graphical user interface 140 showing the user's level of membership at any one time. The graphical user interface 140 illustrates that as the user's participation increases, the membership level would advance and the graphic would progress sequentially from FIG. 6A to FIG. 6F. As shown, there is a stepped increase among three membership levels: (1) “Participant” (text or link shown adjacent bubble 142), (2) “Advanced” (text or link shown adjacent bubble 144), and (3) “Advanced: industry-optimized” (text or link shown adjacent bubble 146). The connected linear relation among the bubbles 142, 144, 146 provide context regarding the progress of participation levels from the initial “Participant” level through the “Advanced” level to the “Advanced: industry-optimized” level. The particular names of the levels and the number of levels can be chosen to best suite the Web application.

FIG. 6A shows the exemplary user interface for a user at the initial “Participant” level. The interface shows the level text in bold print, and highlights the adjacent bubble. A pre-defined user action, such as using the mouse pointer to hover over the bold-face level text or highlighted bubble causes the interface to provide additional links to “Your current benefits” 150 as a Participant and “Next steps” 151 to increasing the participation level. FIG. 6B also shows the user interface for a user at the initial “Participant” level (indicated by bold print and highlighted bubble), but upon moving the mouse pointer to hover over the bubble 144 or the “Advanced” text shown adjacent bubble 144 causes the interface to remove the display of links to “Your current benefits” 150 and “Next steps” 151 at the Participant level and replace them with links “How to qualify” 152 for the Advanced participation level and how to “Earn more benefits” 153 associated with the Advanced level. Finally, in FIG. 6C, the last of the Participant level user interfaces may, upon moving the mouse pointer to hover over the bubble 146 or the “Advanced: industry-optimized” text shown adjacent bubble 146, cause the interface to remove the display of links “How to qualify” 152 and “Earn more benefits” 153 at the Advanced level and replace them with links to “How to qualify” 152 for the “Advanced: industry-optimized” participation level and how to “Earn more benefits” 153 associated with the “Advanced: industry-optimized” participation level.

FIGS. 6D-E shows the user interface for a user at the “Advanced” level. In FIG. 6D, the interface shows the level text in bold print, highlights the adjacent bubble, and, based on user actions described previously, namely moving the mouse pointer to hover over the bubble or the text of the current level, the interface dynamically provides links to “Your current benefits” 150 at the Advanced level and “Next steps” 151 to increasing the participation level further. FIG. 6E also shows the user interface for a user at the “Advanced” level, but again based on user actions described previously, namely moving the mouse pointer to hover over the bubble or the text of the next level, the interface dynamically provides links “How to qualify” 152 for the “Advanced: industry-optimized” participation level and how to “Earn more benefits” 153 associated with the “Advanced: industry-optimized” participation level.

The user interface is shown in FIG. 6F for a user at the “Advanced: industry-optimized” participation level, as indicated by the level text being in bold print and adjacent bubble being highlighted. Because this is the highest level in this example, the only link shown is a link to “Your current benefits” 150 as the “Advanced: industry-optimized” level. As shown in FIGS. 6A-F, the user interface is used to show the user's current participation level in relation to other participation levels and to gradually give the user more information about additional benefits available and how to advance to the next level. Still, the present invention encompasses any number of membership levels.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for displaying user participation in a Web application, comprising:
establishing at least one predetermined rule for a plurality of user participation levels based upon an amount of at least one parameter of activity on a Web application server;
measuring an amount of the at least one parameter of activity that is attributable to a particular registered user;
applying the at least one predetermined rule to the measured amount of the at least one parameter to determine a current participation level for the registered user; and
providing the registered user with a graphical user interface that displays the current participation level of the registered user in relation to the plurality of participation levels.

2. The method of claim 1, further comprising:
continuing to measure the amount of the at least one parameter of activity that is attributable to the registered user over a plurality of user sessions with the Web application server.

3. The method of claim 2, wherein the graphical user interface is persistent during each user session with the Web application server.

4. The method of claim 3, further comprising:
providing, using the graphical user interface, the registered user with instructions on activity that will change the current participation level to the next higher level in the plurality of user participation levels.

5. The method of claim 4, further comprising:
providing, using the graphical user interface, the registered user with information about additional benefits available at the next participation level.

6. The method of claim 1, further comprising:
storing the amount of the at least one parameter of activity attributable to the registered user in memory of the Web application server in a database record associated with the registered user.

7. The method of claim 2, further comprising:
measuring the amount of the at least one parameter of activity attributable to the registered user during each user session;
storing, for each user session, the measured amount of the at least one parameter of activity and a user session time-stamp;
wherein the predetermined rule for determining a current participation level considers only the amount of the at least one parameter of activity attributable to the registered user during user sessions occurring in a defined time period.

8. The method of claim 1, further comprising:
providing benefits to the registered user based on the current participation level of the registered user.

9. A computer program product including instructions embodied on a computer readable medium for displaying user participation in a Web application, the instructions comprising:
instructions for establishing at least one predetermined rule for a plurality of user participation levels based upon an amount of at least one parameter of activity on a Web application server;
instructions for measuring an amount of the at least one parameter of activity that is attributable to a particular registered user;
instructions for applying the at least one predetermined rule to the measured amount of the at least one parameter to determine a current participation level for the registered user; and
instructions for providing the registered user with a graphical user interface that displays the current participation level of the registered user in relation to the plurality of participation levels.

10. The computer program product of claim 9, further comprising:
instructions for continuing to measure the amount of the at least one parameter of activity that is attributable to the registered user over a plurality of user sessions with the Web application server.

11. The computer program product of claim 10, wherein the graphical user interface is persistent during each user session with the Web application server.

12. The computer program product of claim 11, further comprising:
instructions for providing, using the graphical user interface, the registered user with instructions on activity that will change the current participation level to the next higher level in the plurality of user participation levels.

13. The computer program product of claim 12, further comprising:
instructions for providing, using the graphical user interface, the registered user with information about additional benefits available at the next higher participation level.

14. The computer program product of claim 9, further comprising:
instructions for storing the amount of the at least one parameter of activity attributable to the registered user in memory of the Web application server in a database record associated with the registered user.

15. The computer program product of claim 10, further comprising:
instructions for measuring the amount of the at least one parameter of activity attributable to the registered user during each user session;
instructions for storing, for each user session, the measured amount of the at least one parameter of activity and a user session time-stamp;
wherein the predetermined rule for determining a current participation level considers only the amount of the at least one parameter of activity attributable to the registered user during user sessions occurring in a defined time period.

16. The computer program product of claim 9, further comprising:
providing benefits to the registered user based on the current participation level of the registered user.
